(19) United States
(12) Patent Application Publication
(10) Pub. No.: US 2025/0005445 A1
(43) Pub. Date: Jan. 2, 2025

(54) MONITORING HEALTH OF NETWORK APPLICATION BY COMBINING PREDICTIONS FROM DISPARATE DATA SOURCES

(71) Applicant: Royal Bank of Canada, Toronto (CA)

(72) Inventors: Ali HASSAN, Toronto (CA); AmirReza OGHBAEE, New York, NY (US); Marat KHANDROS, New York, NY (US)

(21) Appl. No.: 18/526,561

(22) Filed: Dec. 1, 2023

Related U.S. Application Data
(60) Provisional application No. 63/524,119, filed on Jun. 29, 2023.

(51) Int. Cl. G06N 20/00

(52) U.S. Cl. CPC G06N 20/00

(57) ABSTRACT

An application outage on a computer network can be predicted by combining a utilization prediction of future application-level network utilization for an application executing on the network with an application health score for the application derived from multiple sources into a combined health score for the application. A threshold test can be applied to the combined health score, and remedial action may be initiated in response to the combined health score failing the threshold test. The remedial action may be, for example, an alarm and/or an automated correction procedure.

### CROSS-REFERENCE TO RELATED APPLICATION

This application claims priority to U.S. Provisional Application No. 63/524,119 filed on Jun. 29, 2023, the teachings of which are hereby incorporated by reference.

### TECHNICAL FIELD

The present disclosure relates to network management, and more particularly to monitoring the health of network applications to predict outages.

### BACKGROUND

Many companies rely heavily on information technology (IT) to support their operations. Where a computer network provides outwardly facing services to users, for example in online commerce applications such as banking, charity, retail and reservations, delays in identifying and correcting IT problems can lead to frustration and loss of custom. Therefore, any IT incidents or outages could disrupt critical business processes, resulting in financial losses and damage to the company's reputation.

Internal monitoring of computer networks is well known, and a range of software and other tools are available for this purpose. For example, the Moogsoft® software offered by Moogsoft (Herd) Inc. having an address at 1160 Battery Street East, 1st Floor, San Francisco, CA 94111 can ingest and process network information and provide suitable notifications to the network administrator(s). Prometheus is an open source software project that also provides for network monitoring and alerts.

Even with suitable deduplication, organization and curation, the number of alerts in a large network can be substantial, requiring significant time and attention from the network administrator(s), with a risk of false positives potentially distracting from genuinely impactful problems, especially in real time. Moreover, utilizing historical operational data is challenging due to the size and sparseness of the datasets, as well as noise.

### SUMMARY

Broadly speaking, the present disclosure describes systems, methods and computer program products for predicting an application outage on a computer network by combining a utilization prediction of future application-level network utilization for an application executing on the network with an application health score for the application derived from multiple sources into a combined health score for the application.

A threshold test can be applied to the combined health score, and remedial action may be initiated in response to the combined health score failing the threshold test. The remedial action may be, for example, an alarm and/or an automated correction procedure.

In one aspect, a method for building an application outage predictor is provided. The method comprises training a utilization model to output, from historical application-level network utilization data for a computer network, a utilization prediction of future application-level network utilization for an application executing on the computer network. The method further comprises training an application health model to predict, from multimodal application health metric data, an application health score for the application. The multimodal application health metric data comprises a plurality of independent datasets each representing a status of the application within the computer network. Training of the utilization model is independent of training of the application health model. The method further comprises providing a combiner adapted to combine the application health score from the application health model and the utilization prediction from the utilization model into a combined health score for the application.

The method may further comprise providing for conformation of at least one of the application health score and the utilization prediction so that the application health score and the utilization prediction share a common format and are combinable with one another by the combiner.

In one implementation of the method, a conformer is provided and the conformer is adapted to conform the utilization prediction to the format of the application health score by applying a non-linear mapping to the utilization prediction.

The method may further comprise providing an evaluator adapted to apply a threshold test to the combined health score. The evaluator may be configured to initiate remedial action in response to the combined health score failing the threshold test. The remedial action may be an alarm and/or an automated correction procedure.

In some embodiments, the multimodal application health metric data comprises at least Information Technology Service Management (ITSM) data, infrastructure metrics, and outage information for the computer network. The ITSM data may comprise incident management data, problem management data and/or change management data. The infrastructure metrics may comprise server utilization metrics, application-level errors, application-level warnings, deployment metrics and/or build metrics. The outage information may comprise volumetric problem report data from at least one external public Internet platform that is outside of the computer network and that is nonspecific to the application.

The combiner may be adapted to combine the application health score from the application health model and the utilization prediction from the utilization model into the combined health score for the application by taking a weighted average of the application health score and the utilization prediction.

The utilization model may be a neural network model, and in particular embodiments may be a Long Short Term Memory (LSTM) neural network model.

The application health score may indicate a probability of failure of the application.

In another aspect, a method for predicting an application outage on a computer network is provided. The method comprises receiving, from a trained utilization model, a utilization prediction of future application-level network utilization for an application executing on the computer network. The method further comprises receiving, from a trained application health model trained independently of the neural network model, an application health score for the application. The method combines the application health score from the application health model and the utilization prediction from the neural network model into a combined health score for the application.

In some embodiments, the method further comprises, before combining the application health score and the utilization prediction, conforming at least one of the application health score and the utilization prediction so that the application health score and the utilization prediction share a common format and are combinable with one another by the combiner. The conforming may be performed by a conformer operating independently of the combiner, or by the combiner. In one embodiment, the utilization prediction from the utilization model is conformed to a format of the application health score from the application health model. In a particular embodiment, the utilization prediction from the utilization model is conformed to a format of the application health score from the application health model by applying a non-linear mapping to the utilization prediction from the utilization model.

Alternatively, the application health model and the utilization model may be configured so that the application health score and the utilization prediction share a common format.

The method may further comprise applying a threshold test to the combined health score, and may yet further comprise initiating remedial action in response to the combined health score failing the threshold test. The remedial action may be an alarm and/or an automated correction procedure.

The utilization model may predict the future application-level network utilization from historical application-level network utilization data for the computer network, and the application health model may predict from multimodal application health metric data. The multimodal application health metric data may comprise at least ITSM data, infrastructure metrics, and outage information for the computer network.

Combining the application health score and the utilization prediction may comprise taking a weighted average of the application health score and the utilization prediction.

In some embodiments, the utilization model is a neural network model, and in particular embodiments is a Long Short Term Memory (LSTM) neural network model.

The application health score may indicate a probability of failure of the application.

In yet another aspect, a computer program product comprises a tangible, non-transitory computer-readable medium embodying instructions which, when executed by at least one processor, cause implementation of any of the above-described methods.

In still a further aspect, a data processing system comprises at least one processor and memory coupled to the at least one processor wherein the memory stores instructions which, when executed by the at least one processor, cause the data processing system to implement any of the above-described methods.

### BRIEF DESCRIPTION OF THE DRAWINGS

These and other features of the invention will become more apparent from the following description in which reference is made to the appended drawings wherein:

FIG. 1 shows an illustrative network of computer networks;

FIG. 2 shows a block diagram depicting an illustrative server computer;

FIG. 3 is a schematic representation of an illustrative system for predicting an application outage within a computer network;

FIG. 4 is a graph showing a comparison of actual network utilization to a prediction made by a utilization model comprising a trained LSTM neural network;

FIG. 5 is a flow chart showing an illustrative method for predicting an application outage in a computer network; and

FIG. 6 is a flow chart showing an illustrative method for building an application outage predictor.

### DETAILED DESCRIPTION

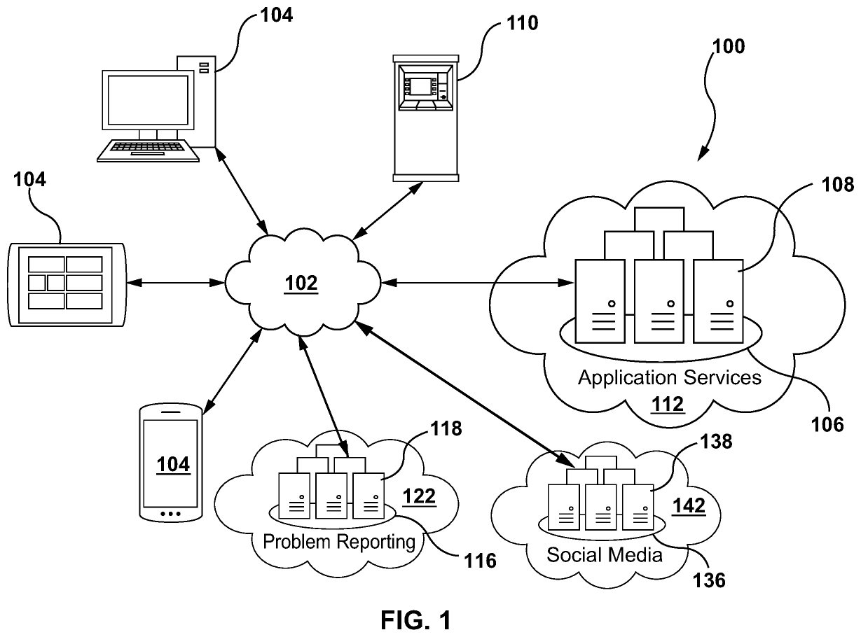

Referring now to FIG. 1, there is shown an overall network 100 that comprises an example embodiment of a system in respect of which methods for detecting network anomalies according to aspects of the present disclosure may be implemented. The overall network 100 is a network of smaller computer networks. More particularly, the overall network 100 comprises a wide area network 102 such as the Internet to which various user devices 104, an ATM 110, and a first data center 106 are communicatively coupled. The first data center 106 comprises a number of servers 108 networked together to form a first computer network 112 to collectively perform various computing functions; the first computer network 112 formed by the servers 108 of the first data center 106 is a component of the larger network 100, and provides application services, which may include public-facing application services. For example, in the context of a financial institution such as a bank, the first data center 106 may host online banking services that permit users to log in to those servers 108 using user accounts that give them access to various computer-implemented banking services, such as online fund transfers. Furthermore, individuals may appear in person at the ATM 110 to withdraw money from bank accounts controlled by the first data center 106. Additionally, the first data center 106 may provide dynamically scalable computing services to internal users, such as investment bankers running various processes to assess risk and predict performance of financial instruments, and/or may provide cloud computing services to external users. Other examples of public-facing application services include online retail services, travel services, communication services, among others. Although the first data center 106 is shown as a single cluster for simplicity of illustration, it is to be understood that there may be a plurality of communicatively coupled data centers, which may be distributed across a plurality of geographical locations, forming the first computer network 112.

One or more second data centers 116 comprise a number of servers 118 networked together to form a second computer network 122 which implements a dedicated problem reporting platform, as described further below, which is coupled to the wide area network 102. One or more third data centers 136 comprise a number of servers 138 networked together to form a third computer network 142 which implements a social media platform. The third computer network 142 is also coupled to the wide area network 102. Both the second computer network 122 which implements the dedicated problem reporting platform and the third computer network 142 that implements the social media platform are external to the first computer network 112 that provides the application services, although they may be connected thereto by the wide area network 102.

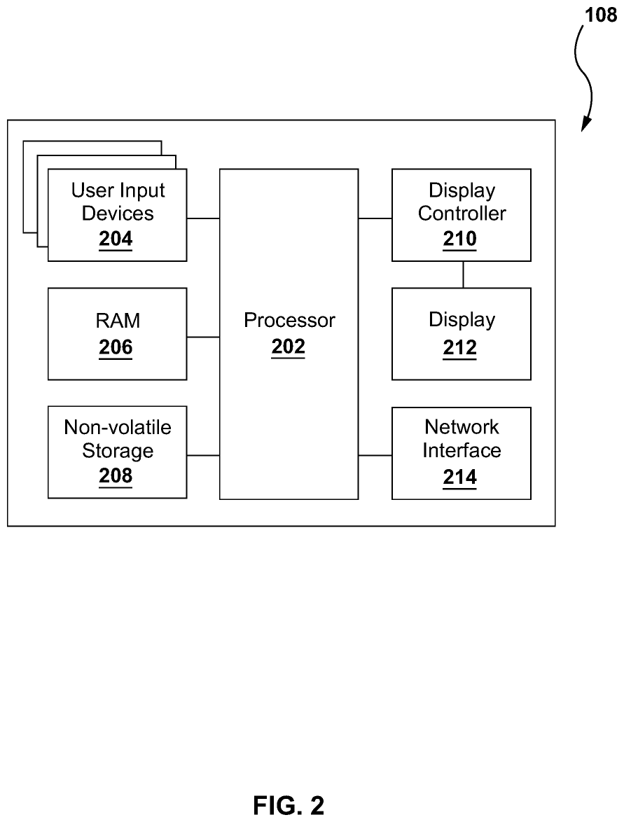

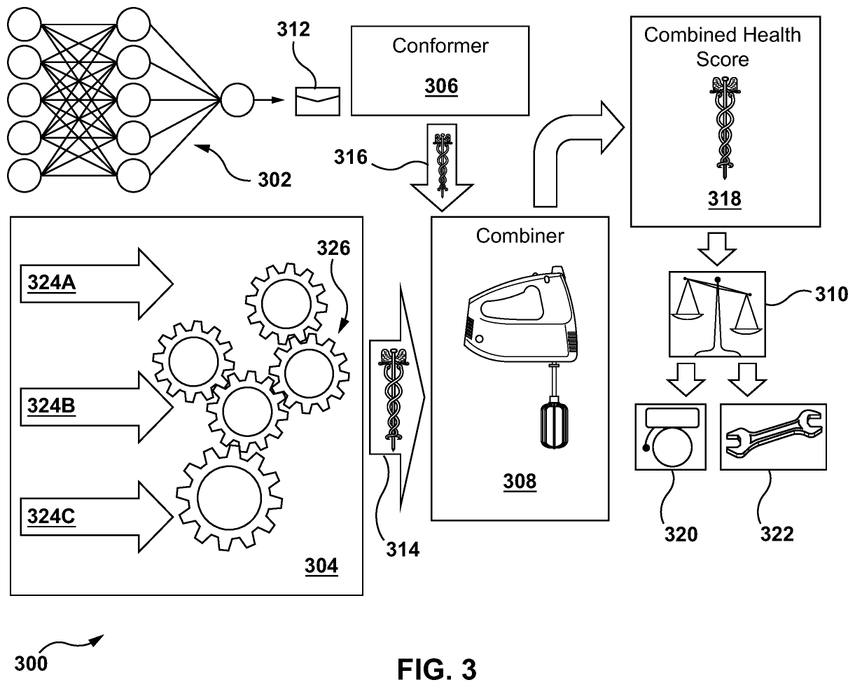

Referring now to FIG. 2, there is depicted an example embodiment of one of the servers 108 that comprises the first data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the processor 202 in conjunction with the RAM 206 at runtime; a display controller 210, which is communicatively coupled to and controls a display 212; and a network interface 214, which facilitates network communications with the wide area network 102 and the other servers 108 in the first data center 106. The non-volatile storage 208 has stored on it computer program code that is loaded into the RAM 206 at runtime and that is executable by the processor 202. When the computer program code is executed by the processor 202, the processor 202 may cause the server 108 to implement a method for predicting an application outage on a computer network as is described in more detail in respect of FIG. 3 below. Additionally or alternatively, the servers 108 may collectively perform that method using distributed computing. While the system depicted in FIG. 2 is described specifically in respect of one of the servers 108, analogous versions of the system may also be used for the user devices 104.

Reference is now made to FIG. 3, which schematically shows an illustrative system 300 for predicting an application outage within a computer network, for example the first computer network 112 that provides the application services. The outage may be an impending outage or an actual outage. The system 300 comprises a trained utilization model 302, a trained application health model 304, a conformer 306, a combiner 308 and an evaluator 310.

The utilization model 302 of the system 300 depicted in FIG. 3 is trained to output, from historical application-level network utilization data, a utilization prediction 312 of future application-level network utilization for an application executing on the network. For example, the application-level network utilization data may be network throughput data. As will be explained in more detail below, in the illustrated embodiment the utilization model 302 is a neural network model.

The trained application health model 304 of the system 300 in FIG. 3 is trained to predict, from multimodal application health metric data representing a status of the network as it relates to the application, an application health score 314 for the application.

The combiner 308 is adapted to combine the application health score 314 from the application health model and the utilization prediction 312 from the utilization model 302 (optionally after conformation by the conformer 306) into a unitary combined health score 318 for the application.

In some embodiments, the application health model and the utilization model are configured so that the application health score and the utilization prediction share a common format. Where, as in the illustrated embodiment, the utilization model 302 and the application health model 304 produce outputs that are in different formats, at least one of the application health score 314 and the utilization prediction 312 must be conformed so that the application health score 314 and the utilization prediction 312 share a common format and are combinable with one another by the combiner 308. This is where the conformer 306 comes into play.

In the illustrated embodiment, the conformer 306 is adapted to conform the utilization prediction 312 from the utilization model 302 to the format of the application health score 314 from the application health model 304; the utilization prediction after conformation is denoted by reference 316. In one embodiment, the conformer 306 is adapted to conform the utilization prediction 312 from the utilization model 302 to the format of the application health score 314 from the application health model 304 by applying a non-linear mapping to the utilization prediction 312 from the utilization model 302. An illustrative implementation of such non-linear mapping is described further below. Thus, in the illustrated embodiment, the conforming operation is performed by a conformer 306 operating independently of the combiner 308. In other embodiments, the conforming operation may be performed by the combiner 308.

The combined health score 318 preferably indicates a probability of failure of the application. For example, the combined health score may be a percentage probability of failure, or the inverse, e.g. probability of failure=100% minus combined health score (represented as a percentage). Alternatively, a scaled score could be used, such as a scale of 1 to 5, or 1 to 10. The combined health score 318 may alternatively indicate the health of the application using a metric other than one indicating a probability of failure of the application. The combined health score 318 may be presented numerically and/or pictorially, such as via a digital dial or gauge, or through the use of colour, or whimsically (e.g. a cartoon image of a person, or an anthropomorphized animal or anthropomorphized computer, growing sicker as the combined health score worsens), or any combination of these.

The evaluator 310 is adapted to apply a threshold test to the combined health score 318, and is configured to initiate remedial action in response to the combined health score 318 failing the threshold test. The remedial action may be, for example, one or both of an alarm 320 and/or an automated correction procedure 322. The alarm 320 may be communicated, for example, by distributing messages according to a pre-established protocol, such as one or more of a Slack channel and/or e-mail and/or pager and/or text/SMS notifications to network administrators, as well as by way of an online dashboard.

The automated correction procedure 322 may be implemented in a number of ways. In one embodiment, a predefined sequence of one or more idempotent tasks could be executed in attempts to fix the problem(s) that resulted in failure of the threshold test. For example, where a common source of application failure can often be remediated by restarting or resetting a certain router in the network, the system 300 may automatically restart or reset that router without human intervention, thereby performing an automated self-healing function in response to the combined health score 318 failing the threshold test. More sophisticated automated pattern analysis and automated problem resolution are also contemplated. One example of a more sophisticated implementation would be self-supervised artificial intelligence configured to determine what actions would be appropriate, and then enact them in a given scenario, with remediation enabled via APIs and remote procedure calls (RPCs). For example, in response to the combined health score 318 failing the threshold test, the system 300 may trigger a bespoke script, or cause an orchestrator to run a sequence of commands against infrastructure/systems where the script or sequence of commands will be idempotent. One suitable non-limiting example of an orchestrator is the Ansible orchestrator offered by Red Hat, Inc. having an address at 100 E. Davie Street, Raleigh, NC 27601, USA (www.ansible.com).

Some details of an illustrative implementation of the utilization model 302 will now be described. In FIG. 3, the utilization model 302 is depicted as a neural network. A neural network is an implementation of artificial intelligence in which interconnected nodes having associated weights and thresholds are arranged in layers, typically including an input layer, one or more hidden layers and an output layer. Training data is provided to enable a neural network to “learn”, and the neural network is then tuned for accuracy. The term “trained”, as used herein, refers to a neural network that has undergone both training and tuning, although further training and tuning may still be possible. While a neural network is a preferred implementation of the utilization model 302, other implementations are also contemplated. For example, a regression model may be used. Where the utilization model 302 is implemented as a neural network, the output will typically not be in the same format as the application health score 314, and hence FIG. 3 depicts an independent conformer 306. It is also contemplated that in some embodiments, a conformer may equivalently be applied to the application health score to conform the application health score to the format of the output of the utilization model.

The utilization model 302 can be trained with any suitable timeframe of historical application-level network utilization data for the application for which an outage is to be predicted. A suitable timeframe is large enough to capture seasonality and repetitive patterns in the application-level network utilization data, and the data collection frequency is likewise calibrated to capture repetitive patterns. Then a horizon prediction can be made for future application-level network utilization data. In preferred embodiments, a window of at least 14 days, with data collection every 5 minutes, is used for collection of the historical application-level network utilization data, and the horizon prediction is a 1-day horizon prediction. The historical application-level network utilization data can be collected by any suitable method, including without limitation from application logs, one or more servers running the application (e.g. servers 108 in FIG. 1) or even an enterprise-level monitoring system. In a preferred embodiment where the utilization model 302 is implemented as a neural network, the neural network is a Long Short Term Memory (LSTM) neural network, more particularly classic LSTM, although other types of LSTM, including gated recurrent unit (GRU) or bidirectional or stacked LSTM models, may also be used. LSTM models are adapted to learn order dependence when dealing with sequence prediction, and are well-suited for time-series forecasting with intrinsic long-term dependencies. Alternatives to LSTM which can be used for the utilization model include but are not limited to neural networks such as Feedforward Neural Networks (FNN), Convolutional Neural Networks (CNN), Recurrent Neural Networks (RNN), Multilayer Perceptron (MLP), Bayesian Neural Networks, Gated Recurrent Units (GRU), Gaussian Process Regression (GPR), Support Vector Regression (SVR), Random Forest Regression, Gradient Boosting Regression, AutoRegressive Integrated Moving Average (ARIMA), Exponential Smoothing, K-Nearest Neighbors, Ensemble methods, DeepAR, Ridge Regression, and Autoencoders. Other suitable neural network models may also be used.

For certain types of secured applications, network traffic for the application in question does not come directly via the Internet as this would be insecure. Instead, a content-delivery network (CDN) between the Internet (e.g. wide area network 102 in FIG. 1) and the network hosting the application (e.g. the first computer network 112) relays the user traffic back to the network hosting the application after performing the required security checks to ensure the authenticity and the benign nature of the traffic. After external validation checks, traffic enters the network hosting the application organization at one of a limited number of links (e.g. three links) on the perimeter router. In one embodiment, the historical application-level network utilization data is the summation of all links for the perimeter router that are relevant to the application being monitored. This can be applied more generally for prediction of link utilization in the infrastructure, as anomalous utilization patterns in network traffic may be early warning signs for an application error. In addition, predicting link utilization can assist with proactive (as opposed to reactive) capacity management to support planning for future usage. Furthermore, an accurate baseline for link usage may support the deployment of other machine learning algorithms for anomaly detection and correction.

In one illustrative embodiment, the utilization model 302 was implemented as a classic LSTM neural network. More particularly, after testing various combinations of batch sizes, neurons, and dropouts via both the RandomSearch tuner (available at https://www.tensorflow.org/decision_forests/api_docs/python/tfdf/tuner/RandomSearch and incorporated by reference) and GridSearch tuner (available at https://www.tensorflow.org/tutorials/keras/keras_tuner and incorporated by reference) from TensorFlow, the utilization model 302 was implemented as a classic LSTM neural network using 100 neurons with a batch size of 1, using the hyperbolic tangent (tan h) as the activation function. The training data consisted of decimal values representing link utilization at five-minute intervals, gathering a total of 288 datapoints per day, for a total of 34 days, resulting in a total input size of 9,732. This univariate input dataset was then fed into the LSTM model. Training was done using the TensorFlow early_stopping module (available at https://www.tensorflow.org/api_docs/python/tf/keras/callbacks/EarlyStopping and incorporated by reference) which stops training as soon as the validation loss ceases to improve in each iteration.

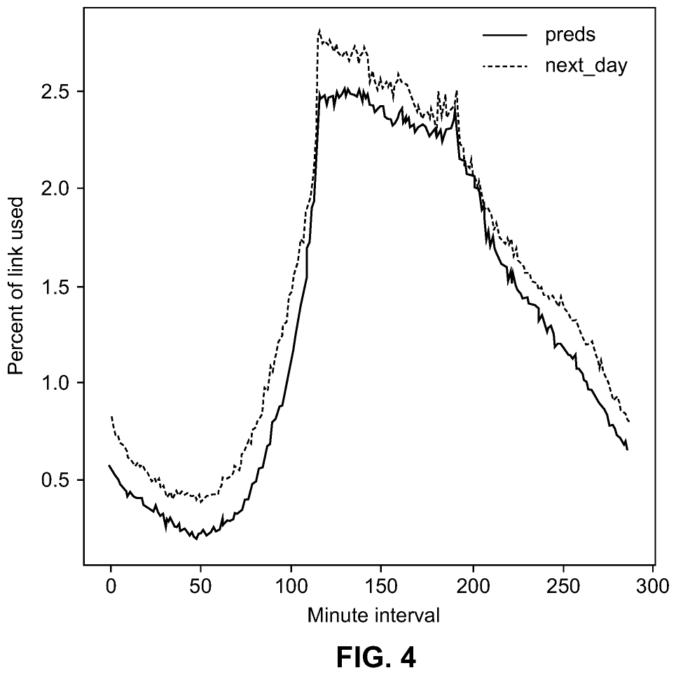

Following training and validation, a trained LSTM neural network implementation of a utilization model 302 produced an accurate prediction with both loss and validation loss decreasing over each trained epoch. FIG. 4 shows a graph reflecting the accuracy of the trained LSTM neural network, with the prediction in solid line and the actual traffic for the day for which the prediction was made in dashed line. The results shown in FIG. 4 reflect test data that was different from the training data, for which weekend data was excluded to focus on critical, business-hours data.

Some details of an illustrative embodiment of the application health model 304 will now be provided, with reference once again to FIG. 3.

The application health model 304 receives respective different types of application health metric data 324A, 324B, 324C as input to an application health prediction algorithm 326. Multimodal application health metric data can be classified into various segments. Multimodal application health metric data may comprise a wide range of application metrics, including, for example, utilization of servers that are running the application (note that this is distinct from the application-level network utilization data ingested by the utilization model 302), the health of downstream and upstream services consumed by the application, or even overall infrastructure health metrics. Multimodal application health metric data can be at the application level (e.g. server logs, runtime errors), and/or infrastructure level (e.g. capacity warning, enterprise-level outage), and will vary based on where the application is deployed. Because there are different types of application health metric data 324A, 324B, 324C, the application health metric data 324A, 324B, 324C is multimodal. The application health prediction algorithm 326 outputs a single application health score 314.

In a preferred embodiment, the multimodal application health metric data 324A, 324B, 324C comprises at least three independent datasets each representing a status of the network as it relates to the application; some embodiments may have more or fewer datasets. Examples of suitable datasets include, but are not limited to, Information Technology Service Management (ITSM) data, infrastructure metrics, and outage information; the foregoing datasets are selected based on availability and are merely non-limiting examples.

The term ITSM is a broad term describing how information technology (IT) teams manage the delivery of IT to the end users thereof. The ITSM data may comprise one or more of incident management data, problem management data and/or change management data. Incident management describes the process or processes used to respond to an unplanned event or service interruption and restore the service to its operational state. Problem management describes the process of identifying and managing the causes of incidents on an IT service. Change management refers to a process for ensuring the use of standard procedures to make changes to IT infrastructure, including deployment of new services, managing existing ones, and resolving problems in the application or network code. These are merely examples and are not intended to be limiting. The ITSM data can be formatted for ingestion into the application health model 304.

The infrastructure metrics may comprise server utilization metrics including but not limited to compute, memory, and storage, application-level errors and warnings from runtime logs, and deployment and build metrics extracted from continuous integration/continuous deployment (CI/CD) pipeline data or manual build logs For example, the Moogsoft® software offered by Moogsoft (Herd) Inc. can ingest and process network information and provide suitable notifications, as can the Prometheus open source project. Other suitable software tools may also be used to acquire the infrastructure metrics.

The outage information may comprises volumetric problem report data from at least one external public Internet platform that is outside of the network and that is nonspecific to the application. For example, in some embodiments, the outage information may be obtained from the dedicated problem reporting platform implemented by the second computer network 122 and/or the social media platform implemented by the third computer network 142. The term “volumetric problem report data” refers to data comprising or derived from problem reports about the application services which conveys information about the volume of those problem reports. It may be an aggregate number of problem reports, with or without weighting and/or other formulaic calculations, and may take other factors into account, such as a geographic origin of the report.

Of note, the external public Internet platform(s) from which outage information is obtained are nonspecific to the application services. The term “external” as used in this context means that the public Internet platform is not hosted by the network in which anomalies are to be detected (e.g. the first computer network 112) and are therefore outside of that network, even if connected thereto by intermediate networks (e.g. wide area network 102). The term “nonspecific to the application services” means that the public Internet platform is adapted to receive information and feedback about topics beyond the application services and the entity providing them. Thus, a public Internet platform that is dedicated to receiving problem reports solely related to the network in which anomalies are to be detected or the entity maintaining it is not “nonspecific to the application services”, even if hosted by a different network than the network in which anomalies are to be detected. For example, a complaint submission platform or customer service/technical support request platform maintained by a retailer, a bank or other service provider in respect of its own products and/or services is not “nonspecific to the application services” hosted by that service provider. However, a complaint submission platform which allows submission of complaints about online retailers generally, or about banks generally, would be “nonspecific to the application services”.

One example of a suitable external public Internet platform is a dedicated problem reporting platform, e.g. the dedicated problem reporting platform implemented by the second computer network 122. A dedicated problem reporting platform is an Internet platform that allows users of a range of public-facing application services, such as social media, Internet service, online commerce, online banking, and the like, to check the status (e.g. availability) of those public-facing application services and/or submit complaints or problem reports. A dedicated problem reporting platform may directly monitor the public-facing application services to determine their status, or may aggregate complaints and reports to infer the status, or both, and may present public information about the availability (or lack thereof) of the public-facing application services. One example of a dedicated problem reporting platform is the Downdetector® platform offered by Ookla, LLC having an address at 1524 5^{TH} Avenue, Suite 300, Seattle WA 98101. The Downdetector platform includes an application programming interface (API) to facilitate integration with internal network monitoring tools, enabling the system 300 to gather volumetric problem report data about the application services directly from the Downdetector platform. Thus, in some embodiments, at least a portion of the volumetric problem report data may be provided directly by the problem reporting platform. Alternatively, subject to compliance with copyright and other laws and any applicable terms of service, the volumetric problem report data may be obtained by crawling or otherwise analyzing public web pages posted by the dedicated problem reporting platform. Thus, in some embodiments, at least a portion of the volumetric problem report data may be generated by analyzing reports posted by the problem reporting platform. Other examples of dedicated problem reporting platforms include isitdownrightnow.com and downforeveryoneorjustme.com. These are merely examples and are not intended to be limiting.

Another example of an external public Internet platform is a social media platform, e.g. the social media platform implemented by the third computer network 142. Well-known social media platforms include the platform formerly officially known as Twitter® (now formally known as “X” but still generally referred to as “Twitter”) operated by X Corp. having an address at 1355 Market Street, Suite 900 San Francisco CA 94103 and the Facebook® platform operated by Meta Platforms, Inc. having an address at 1601 Willow Road, Menlo Park, CA 94025 although these are merely examples of social media platforms and are not intended to be limiting.

In some particular embodiments, volumetric problem report data from one or more social media platforms may be gathered by a dedicated problem reporting platform so that volumetric problem report data from the social media platform(s) is obtained indirectly via a dedicated problem reporting platform while volumetric problem report data from the dedicated problem reporting platform is obtained directly therefrom.

In other embodiments, volumetric problem report data from social media platforms may be obtained by extrapolating problem reports from public posts to the social media platform(s). In some particular embodiments, the public posts, or aggregated data relating to the public posts, may be obtained by integration with an API provided by the social media platform(s). For example, the Twitter/X API enables queries based on keywords; by using a query that contains appropriate keywords to sufficiently identify the application services and capture complaints that the application service is not operating correctly, relevant Twitter/X posts can be gathered. In other particular embodiments, the public web pages of the social media platform(s) may be crawled or otherwise analyzed, of course subject to compliance with copyright and other law and any applicable terms of service. For example, the problem reports may be extrapolated by parsing the posts to identify keywords, or by parsing the posts to identify both keywords and images, such as a company trademark or other indicia, or facsimiles or bastardizations thereof. In this latter embodiment, an image classifier may be used to identify relevant images. Keywords may be, for example, the name or nickname of a company, as well as words indicative of problems with the application services, for example (but not limited to) “down”, “offline”, “slow”, and “broken”. Nicknames may include derogatory nicknames, as the same may reasonably be expected in a complaint. For example, where the public-facing application services are airline reservation services for an airline called “Air[NAME]”, keywords may include not only the actual name “Air[NAME]” but also the derisive nickname “Err[NAME]”. Similar types of keywords may be used for API queries. In addition to simple keyword identification, artificial intelligence approaches may be used to analyze the posts. For example, a trained machine learning classifier could be used to identify posts that indicate a problem with the particular application services. An untrained classifier engine could be trained with social media posts annotated with information about the application services to which the posts relate, then tuned and tested. Natural language processing and/or semantic parsing may also be used.

In one preferred embodiment, after identifying the keywords (and optionally images), the problem reports are disambiguated to exclude problem reports unrelated to the application services. For example, where the application services are for online retail, a problem report relating to the quality of a purchased item should be excluded, because such a problem report is not related to the online retail application services supported by the network but to the underlying retail business. Similarly, where the application services are for online banking, problem reports relating to interest rates or service charges should be excluded as relating to the underlying banking business rather than to the online banking application services supported by the network (e.g. the first computer network 112 formed by the first data center 106). Disambiguation may be performed, for example, by use of additional keywords, or by way of semantic parsing to extract conceptual meaning, or by a trained machine learning classifier.

As noted above, the volumetric problem report data may be weighted; in some embodiments, problem report data from a dedicated problem reporting platform may be weighted differently from problem report data from a social media platform, or the problem report data from different social media platforms may be weighted differently. These are merely illustrative, non-limiting examples of weighting.

In some embodiments, the outage information may be obtained by use of a system such as that described in U.S. patent application Ser. No. 18/338,083 filed on Jun. 20, 2023 and which is hereby incorporated by reference.

In one embodiment, the application health model 304 may be based on the XGBoost library, which is available at the website https://github.com/dmlc/xgboost/blob/36eb41c960483c8b52b44082663c99e6a0de440a/doc/p ython/python_intro.rst and is hereby incorporated by reference. This is merely one illustrative implementation, and is not intended to be limiting. Other suitable implementations of the application health model 304 include a regression model and a classifier (which may be a neural network classifier). Importantly, and in fact critically, the application health model 304 is trained independently of the utilization model 302, even where both are implemented as neural network models. In one non-limiting embodiment, the multimodal application health data 324A, 324B, 324C comprises:
Server Logs: This was the count of alerts generated by the Moogsoft® software and sent to the service desk (labelled as moog-server-alerts), filtered for the servers involved in the functionality for the application for which an outage is to be predicted and sorted by severity; this is a non-limiting example of infrastructure metrics;
Change Risk—This is the daily number of changes of each of low, medium, and high risk level (labelled as cr_low, cr_medium, and cr_high, respectively) relevant to the application for which an outage is to be predicted; this is a non-limiting example of ITSM data. The risk level is calculated based on internal guidelines, typically focused on the criticality of the application and the details of the change, including implementation plan(s), task(s) and blackout plan(s); and
Outage Information—Data from the Downdetector platform, measured as the number of outages reported every 3 minutes for the application for which an outage is to be predicted.

In the illustrated embodiment, the application health model 304 is trained on a combination of the above datasets. Each of the datasets is normalized and the independent features are extracted (optionally with additional encoding and categorization). Then, the normalized datasets are merged on a common time range to be used as the input for the XGBoost model. The illustrated embodiment used the standard XGBoost model with the following parameters, which were identified via hyperparameter tuning of 5-fold combinations (i.e. all possible combinations of the values listed in the table below) that follows each parameter. The cost function that was used to gauge performance was focused on minimizing the Root Mean Squared Log Error (RMSLE):

| | Hypertuned | | | | | | | |
|---|---|---|---|---|---|---|---|---|
| Parameter | Value | | Fine Tuning Combinations | | | | | |
| Gamma | 2000 | 1 | 5 | 100 | 500 | 750 | 1000 | 2000 |
| Eta | 0.5 | 0.5 | 0.25 | 0.1 | 0.01 | 0.001 | | |
| Learning Rate | 0.1 | 0.9 | 0.75 | 0.5 | 0.25 | 0.1 | 0.001 | |
| Max Depth | 8 | 4 | 5 | 6 | 7 | 8 | | |
| N Estimators | 50 | 1 | 50 | 100 | 500 | 750 | 1000 | 2000 |

After training the application health model 304 ingests the above features and produces a numerical value between 0 and 100 representing a health score for the application, with this value then being classified as one of “unhealthy/down”, “degraded service” or “healthy”, that is, reflective of normal business operations. As noted above, this is independent of the utilization model 302.

In one illustrative embodiment, an output value ah_{model}, 0≤ah_{model}≤56 was classified as “unhealthy/down”, an output value 56<ah_{model}≤73 was classified as “degraded” or “potentially degraded” and an output value 73<ah_{model}≤100 was classified as “healthy”. These are merely illustrative, non-limiting ranges.

The chart below shows a set of selected sample datapoints, including the values of the input features and the resulting value output by the classifier:

| | | day- | | moog- | | | | |
|---|---|---|---|---|---|---|---|---|
| | | month- | down- | server- | | | | |
| | timestamp | hour | data | alerts | cr_low | cr_medium | cr_high | classifier |
| 0 | 2023-01-03 | 03-01-00 | 2 | 0 | 0 | 0 | 0 | 100 |
| | 00:02:54 | | | | | | | |
| 1 | 2023-01-03 | 03-01-00 | 6 | 0 | 0 | 0 | 0 | 100 |
| | 00:05:53 | | | | | | | |
| 2 | 2023-01-03 | 03-01-00 | 6 | 0 | 0 | 0 | 0 | 100 |
| | 00:08:54 | | | | | | | |
| 3 | 2023-01-03 | 03-01-00 | 6 | 0 | 0 | 0 | 0 | 100 |
| | 00:12:53 | | | | | | | |
| 4 | 2023-01-03 | 03-01-00 | 8 | 0 | 0 | 0 | 0 | 100 |
| | 00:16:54 | | | | | | | |
| 5 | 2023-01-03 | 03-01-00 | 4 | 0 | 0 | 0 | 0 | 100 |
| | 00:19:54 | | | | | | | |
| 4035 | 2023-01-13 | 13-01-00 | 9 | 2 | 0 | 0 | 0 | 50 |
| | 00:01:55 | | | | | | | |
| 4036 | 2023-01-13 | 13-01-00 | 10 | 2 | 0 | 0 | 0 | 50 |
| | 00:05:54 | | | | | | | |
| 4037 | 2023-01-13 | 13-01-00 | 10 | 2 | 0 | 0 | 0 | 50 |
| | 00:08:55 | | | | | | | |
| 4038 | 2023-01-13 | 13-01-00 | 10 | 2 | 0 | 0 | 0 | 50 |
| | 00:11:54 | | | | | | | |
| 4039 | 2023-01-13 | 13-01-00 | 9 | 2 | 0 | 0 | 0 | 50 |
| | 00:14:56 | | | | | | | |
| 4040 | 2023-01-13 | 13-01-00 | 3 | 2 | 0 | 0 | 0 | 50 |
| | 00:18:55 | | | | | | | |
| 9889 | 2023-01-27 | 27-01-12 | 2 | 1 | 13 | 0 | 0 | 0 |
| | 12:05:13 | | | | | | | |
| 9890 | 2023-01-27 | 27-01-12 | 1 | 1 | 13 | 0 | 0 | 0 |
| | 12:09:12 | | | | | | | |
| 9891 | 2023-01-27 | 27-01-12 | 1 | 1 | 13 | 0 | 0 | 0 |
| | 12:13:12 | | | | | | | |
| 9892 | 2023-01-27 | 27-01-12 | 0 | 1 | 13 | 0 | 0 | 0 |
| | 12:17:14 | | | | | | | |
| 9893 | 2023-01-27 | 27-01-12 | 0 | 1 | 13 | 0 | 0 | 0 |
| | 12:20:12 | | | | | | | |
| 9894 | 2023-01-27 | 27-01-12 | 0 | 1 | 13 | 0 | 0 | 0 |
| | 12:24:13 | | | | | | | |

The accuracy of the above-noted illustrative application health model was tested by feeding the application health model fresh data (data that was different from the training data, and never before encountered by the application health model). The test demonstrated that the application health model was accurate in predicting both degraded and unhealthy traffic patterns corresponding to actual observations for the application.

As noted above, the combiner 308 is adapted to combine the application health score 314 from the application health model and the utilization prediction 312 from the utilization model 302 into a unitary combined health score 318 for the application. Successful combination requires that the application health score 314 and the utilization prediction 312 share a common format and be combinable with one another by the combiner 308. In the illustrated embodiment, this is achieved by the conformer 306 conforming the utilization prediction 312 to the format of the application health score 314, so that the utilization prediction 312 after conformation 316 can be used by the combiner 308. Since the application health score 314 from the application health model 304 has a value 0≤ah_{model}≤100, the utilization prediction 312 after conformation 316, denoted by up_{con}, should also have a value 0≤up_{con}≤100. One illustrative, non-limiting procedure for conformation of the utilization prediction 312 will now be described.

The minimum utilization prediction value upₘᵢₙ from the utilization model is set as a lower bound, and the maximum utilization prediction value upₘₐₓ from the utilization model is set as an upper bound. Then, the range dr of the utilization prediction is calculated by subtracting the lower bound from the upper bound: dr=upₘₐₓ−upₘᵢₙ.

A standardized utilization prediction value up_{std} for a utilization prediction value up from the utilization model can then be obtained by the following formula:

$${up}_{std} = ( ( up - {up}_{min} ) / dr ) * 100$$

Then, a conformed utilization prediction value up_{con} is obtained by applying non-linear mapping to the standardized utilization prediction value up_{std}. In one embodiment, the mapping may be according to the following formula:

$${up}_{con} = ( 2500 - {( {up}_{std} )}^{2} ) / 25$$

The conformed utilization prediction value up_{con} is on the same scale as the application health score; that is, 0≤ah_{model}≤100 and also 0≤up_{con}≤100 in the illustrated embodiment.

The appropriate mapping may be determined by creating an initial mapping using knowledge of the network and application to be monitored, and then testing and refining the initial model. Broadly speaking, where the utilization prediction value up for the link utilization is moderate (neither high nor low), the standardization and mapping should produce a relatively high value for the conformed utilization prediction value up_{con} and where the utilization prediction value up for the link utilization is closer to either extreme (either high or low) then value for the conformed utilization prediction value up_{con} should be relatively low. By way of non-limiting example, according to a presently implemented embodiment, for a utilization prediction value up of 1.03%, which is neither high nor low, the conformed utilization prediction value up_{con} is 95.6, representing “healthy”. Conversely, for a utilization prediction value up of 2.59% which is high, the conformed utilization prediction value up_{con} is 5.48, representing “unhealthy/down”. Preferably, a utilization prediction value up of zero will produce a conformed utilization prediction value up_{con} of zero.

With the utilization prediction 312 conformed 316 to the same format as the application health score 314, i.e. 0≤ah_{model}≤100 and 0≤up_{con}≤100, the combiner 308 can then generate the unitary combined health score 318 for the application.

In one embodiment, the combiner 308 generates the combined health score 318 as a weighted average of the application health score 314 and the utilization prediction 312 as conformed 316. In a preferred embodiment, the application health score 314 is weighted more heavily than the utilization prediction 312. This is because the utilization prediction 312 predicts a single possible outage scenario, whereas the application health score 314 represents a wider range of issues, such as server error logs, changes and independently reported outages. Thus, in one illustrative embodiment, the weighted average may be calculated as:

$$( 0.3 * {up}_{con} ) + ( 0.7 * {ah}_{model} )$$

This is merely an illustrative, non-limiting weighting.

In one illustrative embodiment, for an output value V, 0≤V≤56 was classified as “unhealthy/down”, 56<V≤73 was classified as “degraded” or “potentially degraded” and 73<V≤100 was classified as “healthy”. These are merely illustrative, non-limiting ranges.

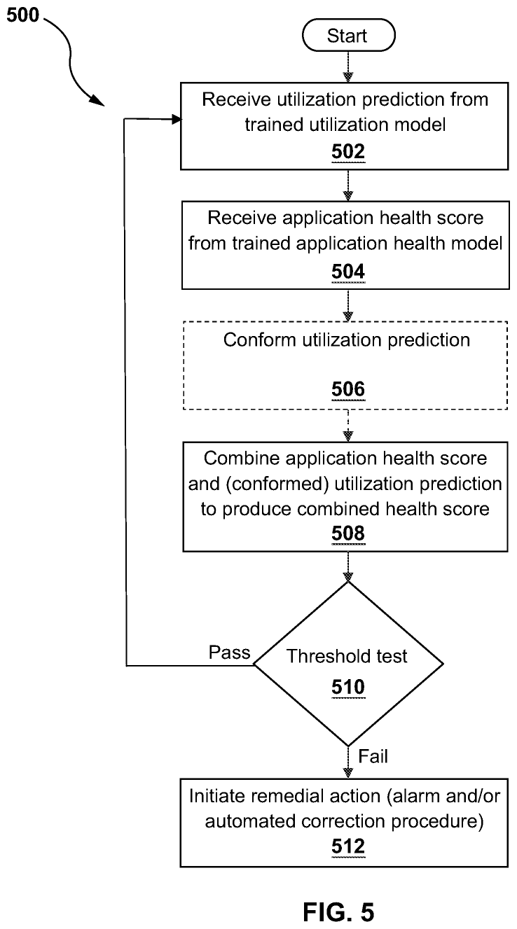

Reference is now made to FIG. 5, which shows an illustrative method 500 for predicting an application outage in a computer network, such as the first computer network 112. At step 502, the method 500 receives, from a trained utilization model (e.g. the utilization model 302 in FIG. 3), a utilization prediction (e.g. utilization prediction 312) of future application-level network utilization for an application executing on the computer network. As noted above, in a preferred embodiment the utilization model predicts from historical application-level network utilization data for the computer network. At step 504, the method 500 receives, from a trained application health model (e.g. application health model 304 in FIG. 3) that is trained independently of the utilization model, an application health score (e.g. application health score 314) for the application. At optional step 506, the method 500 conforms the utilization prediction from the utilization model to the format of the application health score from the application health model to generate a conformed utilization prediction (e.g. conformed utilization prediction 316). Step 506 may be carried out, for example, by applying a non-linear mapping to the utilization prediction from the neural network model, and may be carried out by an independent conformer (e.g. conformer 306), or by a combiner (e.g. combiner 308). Alternatively, if the utilization prediction from the utilization model and the application health score from the application health model are already in compatible formats, or if the method 500 receives a conformed utilization prediction, step 506 may be omitted. Steps 502, 504 and 506 are shown sequentially for purposes of illustration and may be performed in any suitable order.

At step 508, the method 500 combines the application health score from the application health model and the conformed utilization prediction from the utilization model into a combined health score for the application. In one embodiment, step 508 is carried out by taking a weighted average of the application health score and the conformed utilization prediction; other suitable procedures are also contemplated.

The combined health score obtained at step 508 is then subjected to a threshold test at step 510. If the combined health score obtained at step 508 passes the threshold test (“pass” at step 510), the method 500 returns to step 502. However, if the combined health score obtained at step 508 fails the threshold test (“fail” at step 510), the method 500 proceeds to step 512 to initiate remedial action, which may be one or both of an alarm (e.g. alarm 320 in FIG. 3) and/or an automated correction procedure (e.g. automated correction procedure 322 in FIG. 3).

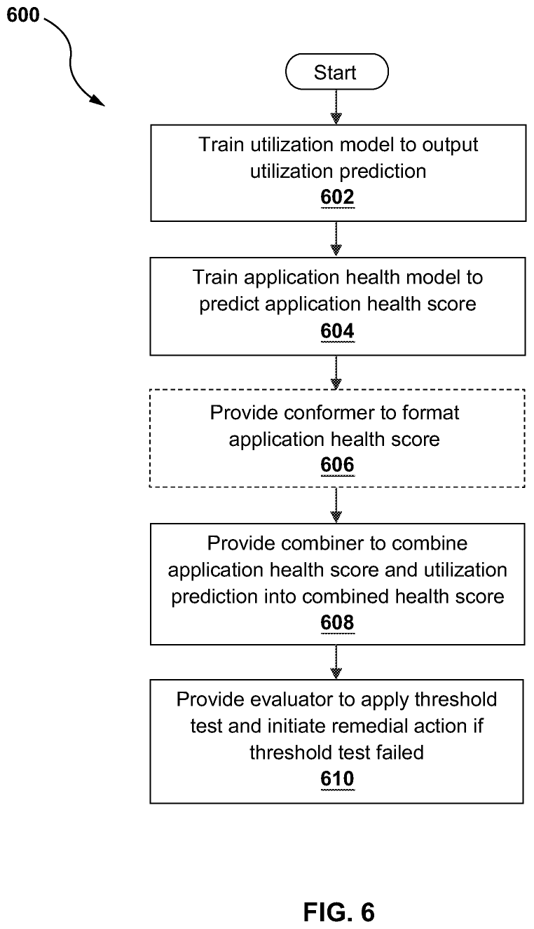

FIG. 6 is a flow chart showing an illustrative method 600 for building an application outage predictor, such as the system 300 shown in FIG. 3. At step 602, the method 600 trains a utilization model (e.g. utilization model 302 in FIG. 3) to output, from historical application-level network utilization data for a computer network, a utilization prediction (e.g. utilization prediction 312 in FIG. 3). The utilization prediction is a prediction of future application-level network utilization for an application executing on the computer network. Preferably, the utilization model is a neural network model, more preferably, an LSTM neural network model, although other models are also contemplated.

At step 604, the method 600 trains an application health model (e.g. application health model 304 in FIG. 3) to predict, from multimodal application health metric data, an application health score (e.g. application health score 314) for the application. Preferably, the application health score indicates a probability of failure of the application. The multimodal application health metric data used for training, and from which predictions are to be generated, comprises a plurality of independent datasets each representing a status of the application within the computer network. The multimodal application health metric data may comprise at least Information Technology Service Management (ITSM) data, infrastructure metrics, and outage information for the computer network. The ITSM data may comprise at least one of incident management data, problem management data or change management data. The infrastructure metrics may comprise at least one of server utilization metrics, application-level errors, application-level warnings, deployment metrics and build metrics. The outage information may comprise volumetric problem report data from at least one external public Internet platform that is outside of the computer network and that is nonspecific to the application.

Importantly, and in fact critically, training of the utilization model (step 602) is independent of training of the application health model (step 604).

In one embodiment, the method 600 may optionally provide for conformation of at least one of the application health score and the utilization prediction so that the application health score and the utilization prediction share a common format and are combinable with one another by the combiner. For example, at optional step 606 the method 600 provides a conformer (e.g. conformer 606 in FIG. 3) that is adapted to conform the utilization prediction to the format of the application health score from the application health model. This may be done, for example, by applying a non-linear mapping to the utilization prediction as described above.

At step 608, the method 600 provides a combiner (e.g. combiner 308 in FIG. 3) adapted to combine the application health score from the application health model and the utilization prediction from the utilization model into a combined health score for the application. The combiner may, for example, take a weighted average of the application health score and the utilization prediction.

At step 610, the method 600 provides an evaluator (e.g. evaluator 310 in FIG. 3) adapted to apply a threshold test to the combined health score. Preferably, the evaluator is configured to initiate remedial action in response to the combined health score failing the threshold test. The remedial action may be, for example, an alarm and/or an automated correction procedure.

Steps 602, 604, 606 and 608 may be performed in any suitable order.

As can be seen from the above description, the application outage prediction technology described herein represents significantly more than merely using categories to organize, store and transmit information and organizing information through mathematical correlations. The application outage prediction technology is in fact an improvement to the technology of computer network monitoring, and is confined to that specific application. Moreover, because it is directed to an improvement in health monitoring for an application executing on a computer network, the present disclosure is explicitly directed to the resolution of a problem in computer network technology, that is, how to detect and address an application failure.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A method for building an application outage predictor, the method comprising:
training a utilization model to output, from historical application-level network utilization data for a computer network, a utilization prediction of future application-level network utilization for an application executing on the computer network;
training an application health model to predict, from multimodal application health metric data, an application health score for the application;
wherein the multimodal application health metric data comprises a plurality of independent datasets each representing a status of the application within the computer network;
wherein training of the utilization model is independent of training of the application health model; and
providing a combiner adapted to combine the application health score from the application health model and the utilization prediction from the utilization model into a combined health score for the application.

2. The method of claim 1, further comprising providing for conformation of at least one of the application health score and the utilization prediction so that the application health score and the utilization prediction share a common format and are combinable with one another by the combiner.

3. The method of claim 1, further comprising providing an evaluator adapted to apply a threshold test to the combined health score, wherein the evaluator is configured to initiate remedial action in response to the combined health score failing the threshold test.

4. The method of claim 3, wherein the remedial action is at least one of an alarm or an automated correction procedure.

5. The method of claim 1, wherein the multimodal application health metric data comprises at least Information Technology Service Management (ITSM) data, infrastructure metrics, and outage information for the computer network.

6. The method of claim 5, wherein the outage information comprises volumetric problem report data from at least one external public Internet platform that is outside of the computer network and that is nonspecific to the application.

7. The method of claim 1, wherein the utilization model is a Long Short Term Memory (LSTM) neural network model.

8. The method of claim 1, wherein the application health score indicates a probability of failure of the application.

9. A computer program product comprising at least one tangible, non-transitory computer-readable medium embodying instructions which, when executed by at least one processor, cause the at least one processor to implement a method according to claim 1.

10. A data processing system comprising at least one processor and memory coupled to the at least one processor wherein the memory stores instructions which, when executed by the at least one processor, cause the data processing system to implement a method according to claim 1.

11. A method for predicting an application outage on a computer network, the method comprising:
receiving, from a trained utilization model, a utilization prediction of future application-level network utilization for an application executing on the computer network;
receiving, from a trained application health model trained independently of the neural network model, an application health score for the application;
combining the application health score from the application health model and the utilization prediction from the neural network model into a combined health score for the application.

12. The method of claim 11, further comprising, before combining the application health score and the utilization prediction, conforming at least one of the application health score and the utilization prediction so that the application health score and the utilization prediction share a common format and are combinable with one another by the combiner.

13. The method of claim 11, wherein the application health model and the utilization model are configured so that the application health score and the utilization prediction share a common format.

14. The method of claim 11, further comprising:
applying a threshold test to the combined health score; and
initiating remedial action in response to the combined health score failing the threshold test.

15. The method of claim 14, wherein the remedial action is at least one of an alarm or an automated correction procedure.

16. The method of claim 11, wherein the utilization model predicts from historical application-level network utilization data for the computer network.

17. The method of claim 11, wherein the application health model predicts from multimodal application health metric data.

18. The method of claim 17, wherein the multimodal application health metric data comprises at least ITSM data, infrastructure metrics, and outage information for the computer network.

19. The method of claim 11, wherein the utilization model is a Long Short Term Memory (LSTM) neural network model.

20. The method of claim 11, wherein the application health score indicates a probability of failure of the application.

21. A computer program product comprising at least one tangible, non-transitory computer-readable medium embodying instructions which, when executed by at least one processor, cause the at least one processor to implement a method according to claim 11.

22. A data processing system comprising at least one processor and memory coupled to the at least one processor wherein the memory stores instructions which, when executed by the at least one processor, cause the data processing system to implement a method according to claim 11.

23. A method for predicting an application outage on a computer network, the method comprising:
combining a utilization prediction of future application-level network utilization for an application executing on the computer network with an application health score for the application derived from multiple sources into a combined health score for the application.

24. The method of claim 23, further comprising:
applying a threshold test to the combined health score; and
initiating remedial action in response to the combined health score failing the threshold test.

25. The method of claim 24, wherein the remedial action is at least one of an alarm or an automated correction procedure.

26. A computer program product comprising at least one tangible, non-transitory computer-readable medium embodying instructions which, when executed by at least one processor, cause the at least one processor to implement a method according to claim 23.

27. A data processing system comprising at least one processor and memory coupled to the at least one processor wherein the memory stores instructions which, when executed by the at least one processor, cause the data processing system to implement a method according to claim 23.
